(19) United States
(12) Patent Application Publication
(10) Pub. No.: US 2008/0054130 A1
(43) Pub. Date: Mar. 6, 2008

(54) Rapidly adjustable arm brace

(76) Inventor: Michael Castner, Dallas, PA (US)

Correspondence Address: RICHARD L. BIGELOW, 203 TREMONT STREET, NEWINGTON, CT, 06111, US

(21) Appl. No.: 11/515,092

(22) Filed: Sep. 1, 2006

(51) Int. Cl. B68G 5/00

(52) U.S. Cl. 248/118

(57) ABSTRACT

A rapidly adjustable arm brace that provides for the steadying of an extended arm of the wearer, particularly the upper arm for shooting, hunting, videographing or other purposes. This rapidly adjustable arm brace incorporates the use of a gas filled air spring to provide the upward force required to hold the extended arm steady for extended periods of time. The gas spring has the additional attribute of allowing the hunter to rapidly and virtually noiselessly increase or decrease the angle of inclination of the extended arm with respect to the horizontal by slightly increasing or decreasing the downward pressure of the extended arm on the air spring.

### CROSS REFERENCE TO RELATED APPLICATIONS

None.

### FEDERAL RESEARCH STATEMENT

None

### BACKGROUND OF THE INVENTION

This invention relates to rapidly adjustable bodily supports or braces and more specifically to a rapidly adjustable brace attachable to the wearer's body or apparel and providing for the steadying of an extended arm of the wearer, particularly the upper arm for shooting, hunting, or other purposes. It is well known that one of the significant challenges of archery, riflery, or video photography is holding the rifle, bow, or camera steady for long periods of time. A significant need has arisen for a mechanism which will provide a quick and virtually noiseless method of adjusting the angle that the bow, rifle, or camera is held at with respect to the horizontal.

This invention not only provides a means of steadying the arm of the person holding a rifle, bow, camera or other such device for extended periods of time, it also provides a means for rapidly and quietly adjusting the angle of inclination with the horizontal of the arm holding said rifle, bow, camera, or other device.

### DESCRIPTION OF THE PRIOR ART

U.S. Pat. No. 5,351,867 issued to Clyde L. Vest on Oct. 4, 1994 reflects the state of the art with respect to arm steadying braces for rifles, bows, cameras, etc. The comprehensive and excellent discussion of the prior art contained in the Vest patent is hereby incorporated into this specification by reference.

None of the patents described in Vest, taken either singly or in combination, are seen to disclose the specific arrangement of concepts disclosed by the present invention.

### SUMMARY OF THE INVENTION

The present invention is directed toward a device that is a rapidly adjustable brace or support designed to steady the arm of a person holding a rifle, archery bow, video camera, or similar device for an extended period of time. The key to the instant invention is that the angle of inclination with the horizontal can be rapidly and virtually noiselessly changed. For ease in understanding the invention, the design and use of the invention will be described in the context of an archery bow hunter.

The Vest patent was a major step forward in the development of steadying braces for archery. However, it had two shortcomings that the present invention overcomes. Although the Vest device was in theory adjustable, the adjusting process was cumbersome, noisy, and time consuming. The present invention solves this problem by presenting a mechanism to allow for quick and virtually noiseless adjustments.

The second major problem of the Vest invention is the difficulty in moving through the forest with a rigid device dangling from the archer's arm. The device frequently becomes entangled in the undergrowth of the forest, thereby slowing the archer's movement and frequently creating noise. The present invention solves this problem by allowing the brace to be folded up snuggly against the upper arm when not in use.

The invention is an integrated brace 10 shown in FIG. 1 that is comprised of a gas filled air spring 40 which is affixed at its upper end to a pad or rest 60, and which has a rounded fitting at its lower end 50. The pad 60 is secured to the arm by straps 20 or other similar device. The lower end 50 of the brace 10 is inserted into a receiver 30 that is located on the belt of the shooter. The lower end 50 of the brace 10 is so designed so that it can move in and out of the receiver 30 rapidly and quietly.

The key mechanism of the brace 10 is a gas filled air spring 40. The functionality and operability of gas filled air springs is well known and understood. The gas filled air spring is shown in more detail in FIG. 2. The gas filled air spring 40 provides upward force that counteracts the force of gravity on the arm which holds the archery bow or other similar device. This allows the bow hunter to hold his or her arm in a raised position for an extended period of time.

One unique feature of this invention is that the gas filled air spring allows the bow hunter to rapidly and quietly change the angle of attack with respect to the horizontal plane. If the hunter wants to lower the angle of attack, he or she simply exerts a small amount of downward force on the brace. The air spring will move down along its longitudinal axis and come to rest at a lowered angle of attack at a point where the downward pressure exerted by the archer on the pad/brace equals the upward force of the air spring.

Conversely, if the archer wants to increase the angle of attack, he or she simply lessens the amount of downward force exerted on the pad/brace which results in the air spring pushing upward on the pad/brace and thereby raising and stabilizing the angle of attack to the point where, once again, the upward and downward forces are equal.

Note that each air spring can be adjusted to the level of sensitivity desired by the archer by releasing gas from the cylinder.

A further innovative feature of the instant invention is that air spring 40 is attached to the pad 60 by a flexible pivotable fitting 65 as is shown in FIG. 4 so that when not in use, the air spring/lower end fitting mechanism can be pivoted into the upper arm so that the archer can move throughout the woods without having a protruding rigid device thrash against the undergrowth thereby creating noise.

### BRIEF DESCRIPTION OF DRAWINGS

FIG. 1 shows the manner in which the brace holds the arm steady while the archer holds a bow 80 out fully extended from his body. FIG. 1 also shows the air spring 40, the means by which the brace is attached to the upper arm by straps 20, and the manner in which the lower end of the air spring is inserted into the receiver 30. The receiver 30 is attached to the archer's belt.

FIG. 2 depicts a closeup of the brace 10 showing the receiver 30, lower end fitting 50, air spring 40, arm rest/pad 60 and fastening straps 20. FIG. 2 also shows the manner in which the piston 48 of the air spring is able to move within the cylinder 49 of the air spring. Also depicted is the quick release mechanism 55 of the air spring which causes the piston 48 to be fully inserted in the cylinder 49 thereby facilitating placing the brace 10 into the “stored” position as is shown in FIG. 4.

FIG. 3 depicts how the archer can steadily and rapidly lower the bow by exerting force with his upper arm on the brace. This figure also shows how the interior piston 48 of the air spring 40 travels into the cylinder 49 of the air spring as downward pressure is exerted.

FIG. 4 shows the manner in which the brace 10 can be placed into the “stored” position for ease in traveling through the forest. The brace is placed into the stored position by pivoting the device around the pivot point 65 and folding it against the pad 60 and upper arm. The air spring 40 is preferably in the fully distended or housed position when the brace is in the stored position. The lower end fitting 50 of the air spring is no longer engaged in the receiver 30 when the brace is in the stored position.

### DETAILED DESCRIPTION OF THE INVENTION

The present invention is directed toward a device that is a rapidly adjustable brace or support designed to steady the arm of a person holding a rifle, archery bow, video camera, or similar device. The unique feature of the instant invention is that it allows the individual holding the rifle, archery bow, video camera, etc. to rapidly and easily adjust the position of the extended arm with respect to the horizontal. For ease in understanding the invention, the design and use of the invention will be described in the context of an archery bow hunter.

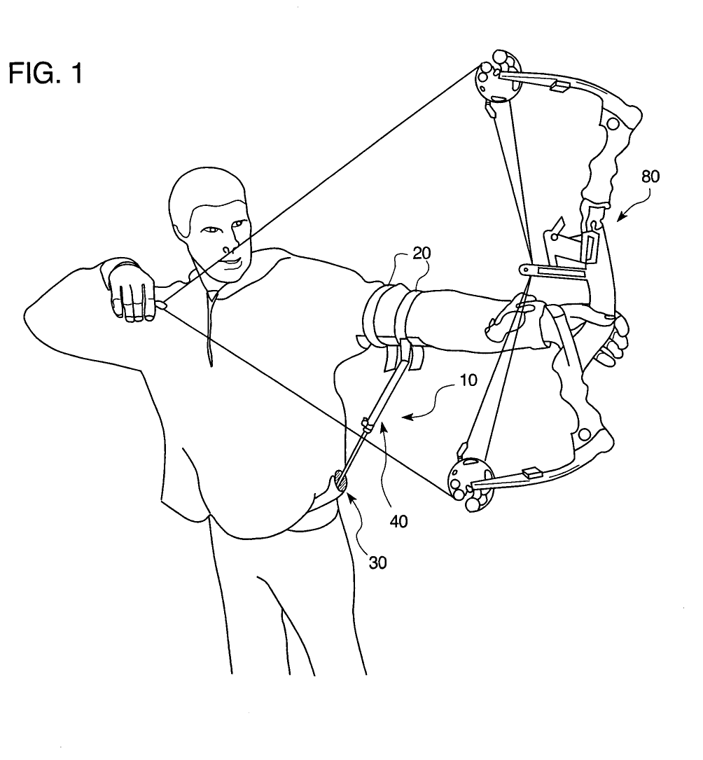

Referring to the figures and in particular to FIG. 1, the functionality of the rapidly adjustable brace 10 is shown in the context of an archer. FIG. 1 shows the archer holding a bow 80 with his left arm fully extended roughly parallel to the horizontal. The brace 10 is shown supporting the archer's arm and holding it steady. The brace 10 is comprised of a gas filled air spring 40 which is attached at its upper end with a flexible pivotable coupling to an arm rest pad 60. The arm rest pad is attached to the archer's arm with a set of straps 20. The lower end of the air spring is placed into a receiver 30 which is preferably attached to the archer's belt.

The receiver 30 is designed so that it can be easily affixed to the archer's belt or affixed in some other manner to the area around the hip corresponding to the extended arm of the archer. The receiver is further designed so that it has a fairly wide opening that tapers to a smaller size such that the lower end fitting 50 of the brace can easily be placed into the receiver 30 and yet be held snuggly in the receiver while the adjustable brace is being used. An alternate embodiment of the lower end fitting—receiver interface is a snap-in configuration.

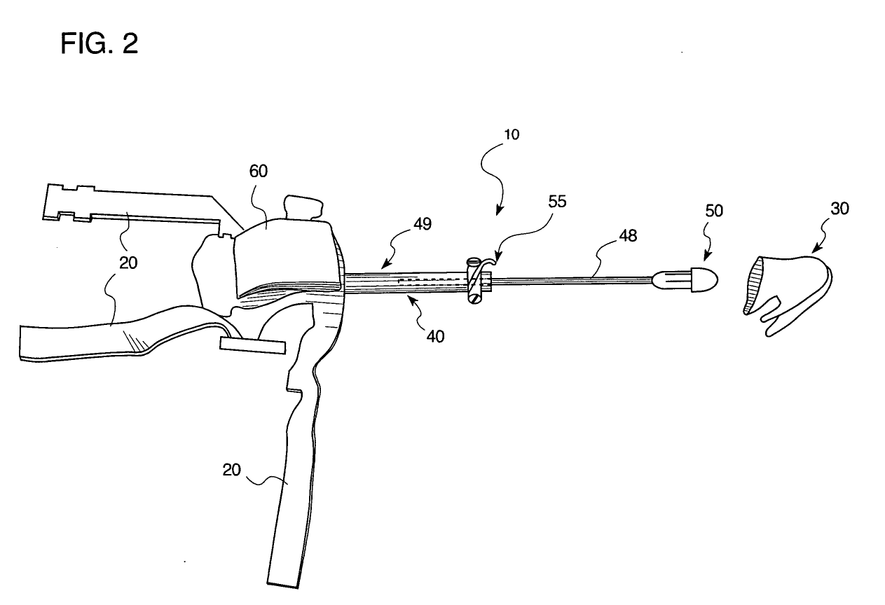

Referring to FIG. 2, a closeup of the brace 10 is shown. The key element of the brace is the gas filled air spring 40. The operation of air springs is well defined and well understood. The gas in the gas filled air spring provides a resistive force to movement of the piston within the cylinder. This resistive force provides the means for holding the extended arm of the archer steady for extended periods of time and well beyond the normal time of fatigue as shown in FIG. 1.

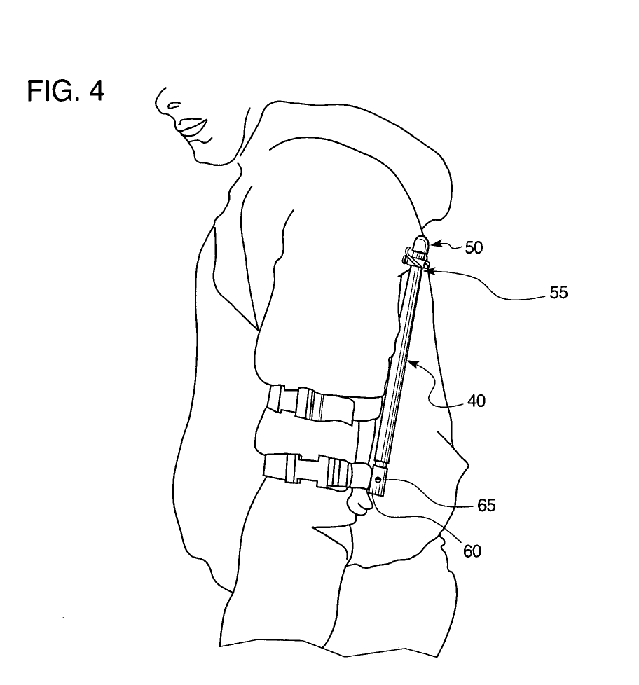

The other key components of the brace 10 are the receiver 30, lower end fitting 50, arm rest/pad 60 and fastening straps 20. FIG. 2 also shows the manner in which the piston 48 of the air spring is able to move within the cylinder 49 of the air spring. Also depicted is the quick release mechanism 55 of the air spring which causes the piston 48 to be fully inserted in the cylinder 49 thereby facilitating placing the brace 10 into the “stored” position as is shown in FIG. 4.

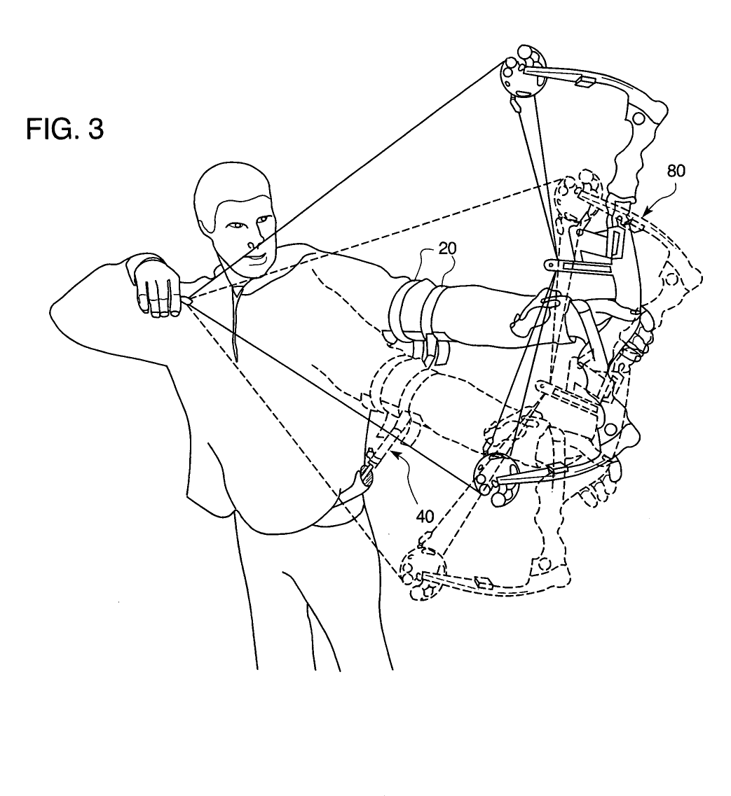

FIG. 3 displays the manner in which the archer can vary the angle of inclination with respect to the horizontal plane by exerting downward pressure with the upper arm on the arm rest 60 which in turn translates the downward force to the attached gas filled air spring. As the upward resistive force of the air spring is overcome by the downward pressure exerted by the upper arm, the entire extended arm—archery bow apparatus increases the negative angle with the horizontal plane. When the arm—bow apparatus is at the desired angle of inclination, the archer reduces the downward pressure until the arm—bow apparatus is at rest at the required angle with the horizontal.

Conversely, when the archer wants to decrease the angle with respect to the horizontal, he or she merely reduces the downward pressure on the pad—airspring mechanism and allows the upward pressure of the air spring to slowly move the arm—bow apparatus upward.

The increases and decreases of the angle of inclination of the arm—bow apparatus with the horizontal plain can be accomplished with very small changes (increases or decreases) in the downward pressure of the arm—bow apparatus on the gas air spring. The angle of inclination can also be accomplished very rapidly and virtually noiselessly, which is very important to an archer, a riflery marksman, and even a videographer. An additional feature of the gas air spring is that the amount of resistivity inherent in the air spring can be adjusted to meet the desires of the individual archer, rifleman, or videographer by adding or deleting gas.

The ability to vary the angle of inclination of the arm—bow apparatus rapidly, continuously, and virtually noiselessly is the key facet of the instant invention. This ability to vary the angle of inclination in such a manner is very important to a hunter, as can be demonstrated by the example of a bow hunter in a tree stand which is often located about ten feet above the ground. One of the key requirements for successful bow hunting from such a stand is the requirement to remain very quiet, since forest animals can be scared away with only the slightest noise. As an animal appears, the hunter can vary the angle with the horizontal rapidly and noiselessly so as not to scare away the animal. This ability was not present in the prior art.

FIG. 4 shows how the rapidly adjustable arm brace can be placed into the “stored” position by pivoting the gas air spring 40 around the pivot mechanism 65 that affixes the air spring 40 to the arm rest 60. Ideally, the piston of the air spring 48 should be fully inserted into the cylinder 49 of the air spring when placing the apparatus into the stored position. This is accomplished by operating the quick release mechanism 55 which releases gas and thereby allows the piston 48 to fully enter the cylinder 49.

Placing the brace 10 into the stored position allows the hunter to move rapidly and quietly throughout the forest without a bulky rigid, non-storable brace thrashing against forest growth.

The best mode for practicing this invention is to have a rapidly adjustable arm brace that is comprised of a gas filled air spring with a quick release mechanism pivotably affixed at one end to an arm rest that is affixed with straps to the upper arm of the user and which has a rounded end fitting at the other end which can easily fit into and engage an independent receiver, which is separately attached to the hunter's belt.

The following is claimed:

1. A rapidly adjustable arm brace comprising the following:
a. an arm rest that is attached to an individual's arm;
b. a gas filled air spring that is attached at one end to the arm rest and unattached at the opposite end;
c. a conical device that is attached to the waist of an individual and which can receive and hold in place the unattached end of the gas air spring.

2. The rapidly adjustable arm brace of claim 1 wherein the arm brace is attached to the arm of an individual with straps.

3. The rapidly adjustable arm brace of claim 1 wherein the gas filled air spring has a quick release mechanism.

4. The rapidly adjustable arm brace of claim 1 wherein the pressure and resistance of the gas filled air spring can be adjusted.

5. The rapidly adjustable arm brace of claim 1 wherein the unattached end of the gas filled air spring has a rounded end fitting.

6. The rapidly adjustable arm brace of claim 1 wherein the gas filled air spring is pivotably attached to the arm rest.

7. The rapidly adjustable arm brace of claim 1 wherein the arm rest is attached to the upper arm of an individual.

8. An adjustable arm brace comprising the following:
a. an arm rest that is attached to an individual's arm;
b. a pressure resistant device that is attached at one end to the arm rest and unattached at the opposite end;
c. a device that is attached to the waist of an individual and which can receive and hold in place the unattached end of the pressure resistant device.

9. The adjustable arm brace of claim 8 wherein the arm brace is attached to the arm of an individual with straps.

10. The adjustable arm brace of claim 8 wherein the pressure inherent in the pressure resistant device can be adjusted.

11. The adjustable arm brace of claim 8 wherein the unattached end of the pressure resistant device has a rounded end fitting.

12. The adjustable arm brace of claim 8 wherein the pressure resistant device is pivotably attached to the arm rest.

13. The adjustable arm brace of claim 8 wherein the arm rest is attached to the upper arm of an individual.
